(19) United States
(12) Patent Application Publication
(10) Pub. No.: US 2021/0301854 A1
(43) Pub. Date: Sep. 30, 2021

(54) Blind Fastener

(71) Applicants: Newfrey LLC, New Britain, CT (US); University Public Corporation Osaka, Osaka (JP)

(72) Inventors: Kanji SAKODA, Toyohashi-Shi (JP); Takashi YAMAGUCHI, Osaka (JP)

(73) Assignees: Newfrey LLC, New Britain, CT (US); University Public Corporation Osaka, Osaka (JP)

(21) Appl. No.: 17/209,994

(22) Filed: Mar. 23, 2021

(30) Foreign Application Priority Data
Mar. 26, 2020 (JP) 2020-055374

(51) Int. Cl. F16B 19/10

(52) U.S. Cl. CPC F16B 19/1054; F16B 19/1063

(57) ABSTRACT

The present invention is equipped with a shaft 11; a bolt 10 having a head 12 with a diameter larger than that of the shaft at a first-side end of the shaft; a first sleeve 20 having a cylindrical shape through which the shaft is inserted, a first-side end of which abuts on the head and the other-side end of which enters a fastening hole 103; a washer 30 having a tubular shape through which the shaft is inserted, arranged adjacent to the first sleeve on the other-end side of the first sleeve so as to be in contact with a member to be fastened 101, a first-side end thereon entering the fastening hole; and a nut 40 that is placed adjacent to the washer and screwed into the bolt; wherein tapered surfaces 310 and 32a, which are tapered toward the other-side end of the first sleeve, are formed on the washer in contact with the member to be fastened and on the first-side end thereof, respectively; a tapered surface 21 whose diameter increases toward the first-side end of the washer is formed at the other-side end of the first sleeve; and the other-side end of the first sleeve and first-side end of the washer are in contact with each other on both tapered surfaces.

### CROSS-REFERENCE TO RELATED APPLICATION

This application claims the benefit and priority of Japanese Patent Application No. 2020-055374, filed Mar. 26, 2020, the entire disclosure of which is incorporated herein by reference.

### FIELD

The present invention relates to a blind fastener.

### BACKGROUND

This section provides background information related to the present disclosure which is not necessarily prior art.

Conventionally, a blind fastener is known as a member for fastening a plurality of members to be fastened. The blind fastener is a fastening member that can be fastened by an operation from one side of the member to be fastened even when the operation cannot be performed on the back side of the member to be fastened.

As such blind fastener, a method of fastening a plurality of members to be fastened by friction welding is known. In the friction stir welding method, a plurality of members to be fastened are tightened by the axial force of a bolt; these members are fixed by friction between the plurality of members to be fastened.

### PRIOR ART

Japan Patent No. 3,816,130

### SUMMARY

This section provides a general summary of the disclosure, and is not a comprehensive disclosure of its full scope or all of its features.

In the friction-fastening method, the fastening force of a plurality of members to be fastened may not be sufficient, and improving the fastening force has been necessary. In order to increase the fastening force by friction-fastening, it is possible to increase the axial force of the bolt by increasing the shaft diameter of the bolt. However, in this case, the diameter of the hole of the member to be fastened into which the bolt is inserted must be increased, and since the cross-sectional defect of the member to be fastened is magnified, the strength of the member to be fastened itself may decrease. For example, when inserting bolts into the fastening holes arranged in multiple rows and columns for friction-fastening, if the diameter of each fastening hole is increased, the strength of the member to be fastened may be significantly reduced.

The present invention was developed to solve such problem; the object of the present invention is to provide a blind fastener capable of improving the fastening force of a plurality of materials to be fastened.

The blind fastener according to an embodiment of the present invention is a blind fastener for fastening a plurality of members to be fastened having fastening holes, equipped with a bolt having a shaft that extends in one direction and is inserted into the fastening hole, and a head with a diameter larger than that of the shaft at one end of the shaft; a first sleeve having a cylindrical shape through which the shaft is inserted, a first-side end of which is in contact with the head and the other-side end of which is inserted into the fastening hole; a washer portion that has a tubular shape through which the shaft is inserted, is arranged adjacent to the first sleeve on the other end side of the first sleeve so as to be in contact with the member to be fastened, a first-side end of which enters the fastening hole; and a nut arranged so as to be adjacent to the washer portion and screwed with the bolt; wherein a tapered surface having a diameter reduced toward the other-side end of the first sleeve is formed on a portion of the washer portion in contact with the member to be fastened and the first-side end thereof, a tapered surface whose diameter increases toward the first-side end of the washer is formed at the other-side end of the first sleeve, and the other-side end of the first sleeve and the first-side end of the washer portion are in contact with each other on the tapered surfaces.

According to the present invention, it is possible to obtain a blind fastener that can improve the fastening force of a plurality of materials to be fastened.

### DRAWINGS

The drawings described herein are for illustrative purposes only of selected embodiments and not all possible implementations, and are not intended to limit the scope of the present disclosure.

FIG. 1. is a perspective view of a blind fastener according to an embodiment of the present invention.

FIG. 2 is an exploded perspective view of a blind fastener according to an embodiment of the present invention.

FIG. 3 is a side view of a part of the blind fastener as a cross-section according to an embodiment of the present invention.

FIG. 4 is a side view when the blind fastener is set on the member to be fastened according to an embodiment of the present invention.

FIG. 5 is a side view when a plurality of members to be fastened are fastened with the blind fastener according to an embodiment of the present invention.

FIG. 6 is a cross-sectional view of FIG. 5.

### DETAILED DESCRIPTION

Hereinbelow, embodiments for carrying out the present invention will be described with reference to the accompanying drawings. By assigning the same or similar reference numbers to the same or similar members, duplicate description thereof is omitted. In order to explain the present invention in an easily comprehensible manner, the scale of the drawings is not constant.

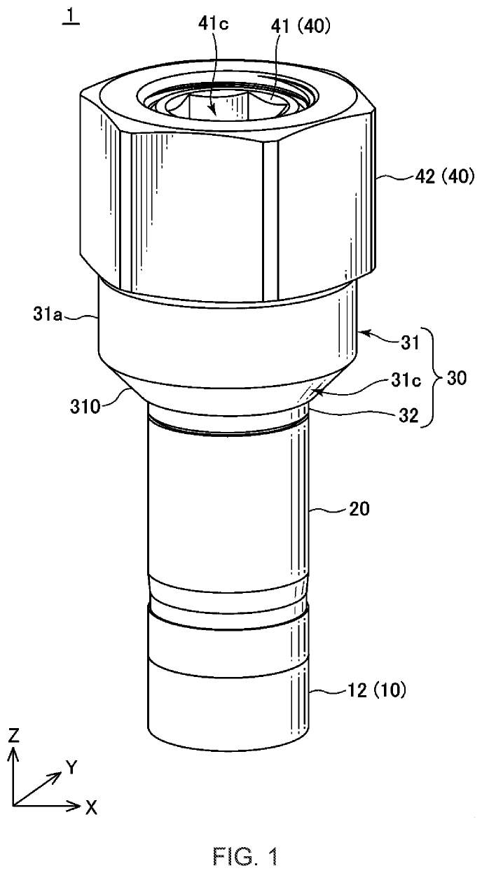

FIG. 1 is a perspective view of a blind fastener according to an embodiment of the present invention.

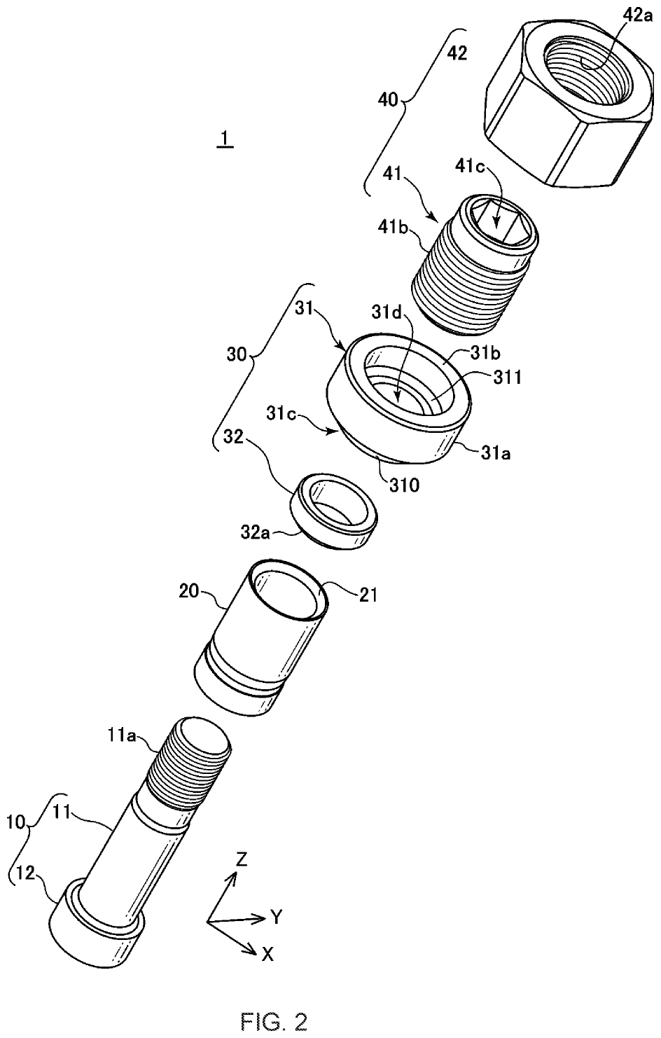

FIG. 2 is an exploded perspective view of a blind fastener according to an embodiment of the present invention.

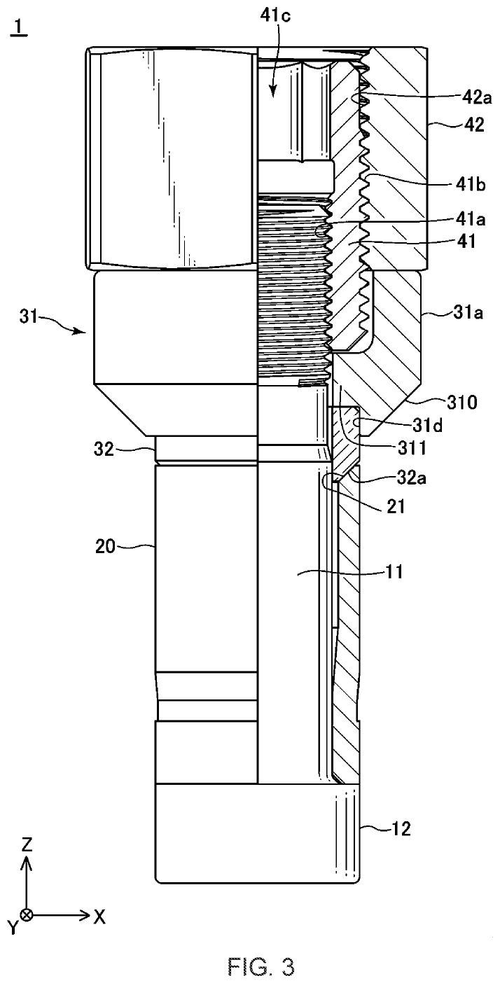

FIG. 3 is a side view of a part of the blind fastener as a cross-section according to an embodiment of the present invention.

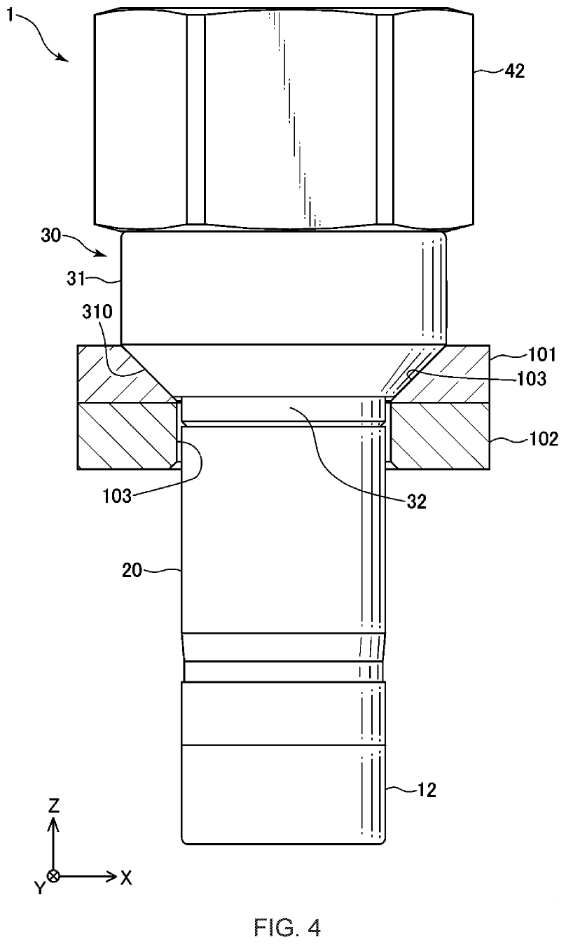

FIG. 4 is a side view when the blind fastener is set on the member to be fastened according to an embodiment of the present invention.

The blind fastener 1 is a component for fastening a plurality of members to be fastened 101 and 102 having fastening holes 103. As shown in FIGS. 1 and 2, the blind fastener 1 is equipped with a bolt 10, a first sleeve 20, a washer 30 and a nut 40.

The bolt 10 has a shaft 11 extending in one direction, and a head 12 having a diameter larger than that of the shaft 11 at a first-side end of the shaft 11. A screw 11a is cut on the other-end side of the shaft 11, and the direction of the screw 11a is a right-handed screw. For the bolt 10, as the screw 11a of the shaft 11, a bolt having a fine screw of M18 or less (that is, a pitch of 2.0 mm or less) can be used. Examples of the standards of such a bolt 10 include JIS B 0205, JIS B 0207 and ISO 724. The pitch is the distance between the screw threads.

In the following description, the direction in which the shaft 11 extends is also referred to as the axial direction. The axial direction is also referred to as the Z-axis direction. Specifically, the head 12 side is in the negative direction of the Z axis, and the tip side of the shaft 11 on the opposite side of the head 12 is in the positive direction of the Z axis.

As shown in FIGS. 1 to 4, the first sleeve 20 has an overall cylindrical shape, and the shaft 11 is inserted into the hollow portion thereof. A first-side end of the first sleeve 20 comes into contact with the head 12, and the other-side end enters the fastening hole 103. That is, the inner diameter of the first sleeve 20 is equal to or larger than the diameter of the shaft 11 and smaller than the diameter of the fastening hole 103, and the outer diameter is equal to or smaller than the diameter of the head 12.

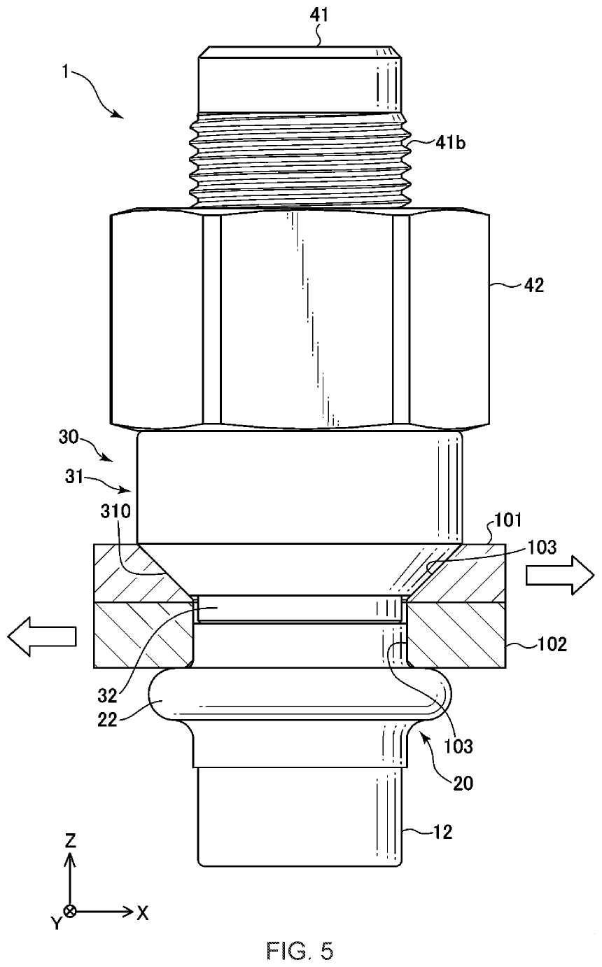

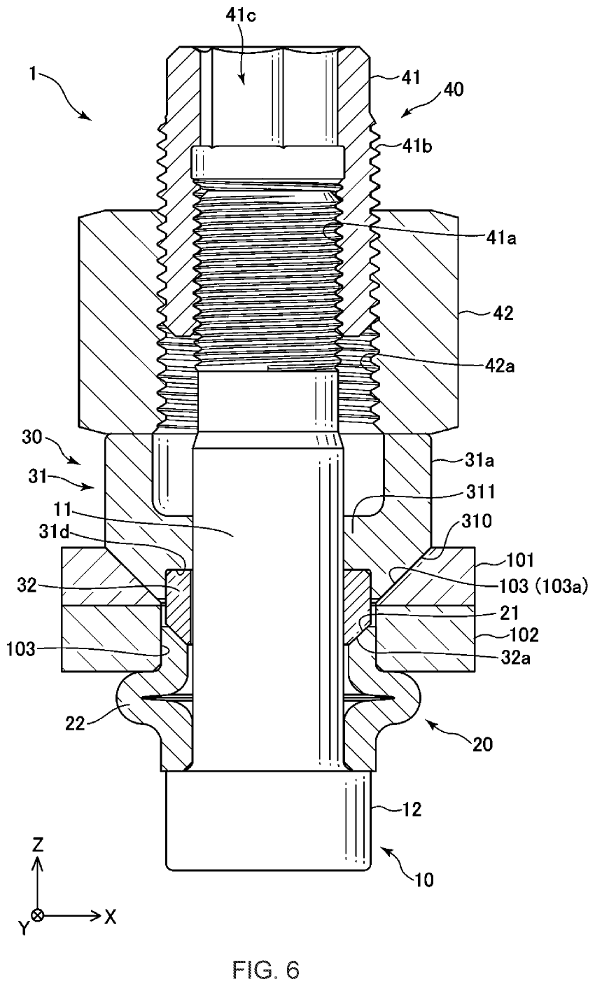

When a compressive force in the axial direction is applied to the first sleeve 20, the portion between the first-side end and the other-side end of the first sleeve 20 bulges outward in a direction orthogonal to the axial direction (see FIGS. 5 and 6 below). In order to facilitate the bulging to the outside, the first sleeve 20 of the present embodiment is formed so that the inner diameter of the other-end side is larger than that of the first-end side (see FIG. 3). For example, in the first sleeve 20, the inner diameter on the first-end side close to the head 12 is the same as the diameter of the shaft 1, and the inner diameter of the other-end side opposite to the head 12 is larger than the diameter of the shaft 11. The first sleeve 20 is preferably made of a material that is easily plastically deformed. In the present embodiment, the first sleeve 20 is made of a material that is more easily plastically deformed than the washer 30; for example, annealed steel (mild steel) can be used. By using pre-annealed steel, it is possible to prevent cracks from occurring even when the first sleeve 20 is deformed.

A tapered surface 21 is formed on the other-side end of the first sleeve 20 (see FIGS. 2 and 3), and the tapered surface 21 comes into contact with the washer 30. The tapered surface 21 is formed so as to increase in diameter toward the washer 30 adjacent to the first sleeve 20. In other words, the other-side end of the first sleeve 20 has a constant outer diameter, while the inner diameter increases toward the washer 30.

As shown in FIGS. 1 to 4, the washer 30 has a tubular shape, a shaft 11 penetrating fastening hole 103 is inserted into the hollow portion, and is arranged adjacent to the first sleeve 20 on the other-end side of the first sleeve 20 so as to be in contact with the member to be fastened 101. One end of the washer 30 enters the fastening hole 103.

Specifically, the washer 30 has a counter washer 31 and a second sleeve 32. The counter washer 31 has a cylindrical body 31a through which the shaft 11 is inserted, a contact surface 31b provided at the end of the body 31a and in contact with the nut 40, a tapered portion 31c provided so as to narrow in the negative direction of the Z axis from the other end on the side opposite to the end of the body 31a, and a recess portion 31d provided at the tip where the tapered portion 31c is provided. The tapered portion 31c is configured to have a diameter reduced toward the first sleeve 20, and a tapered surface 310 is formed on the outer surface thereof.

The second sleeve 32 is fitted in the recess portion 31d. In the present embodiment, the recess portion 31d is provided with an extending portion 311 extending from the inner circumference of the counter washer 31 toward the center. The second sleeve 32 is fitted in the space formed by the extending portion 311 and the inner circumference of the tapered portion 31c. The extending portion 311 projects in the central direction over the entire circumference around the shaft 11 and has a ring shape, but may be radial. The extending portion 311 is extended toward the center so as not to come into contact with the shaft 11, and supports the shaft 11 even if the bolt 10 is laterally displaced on the XY plane orthogonal to the Z-axis direction.

The second sleeve 32 has a cylindrical shape, a first-side end of which is fitted into the recess portion 31d, and the other-side end of which is reduced in diameter toward the tip. Specifically, the second sleeve 32 is fitted into the recess portion 31d, a first-side end of which is in contact with the bottom surface of the recess portion 31d, and a tapered surface 32a is formed at the other-side end. The tapered surface 32a is formed so that the diameter is reduced toward the other-side end of the first sleeve 20, and the tapered surface 32a becomes the tapered surface of the washer 30.

The second sleeve 32 may be made of a flexible material, but in the present embodiment, the material is more easily plastically deformed than the counter washer 31; for example, steel can be used.

In the present embodiment, the washer 30 is composed of separate members of the counter washer 31 and the second sleeve 32; however, if the shape is similar to the shape of the entire combination of the counter washer 31 in which the second sleeve 32 is fitted into the recess portion 31d and the second sleeve 32, the washer 30 may be an integrally molded product composed of one member.

As shown in FIGS. 1 to 4, the nut 40 is arranged so as to be adjacent to the washer 30 and is screwed with the bolt 10. In the present embodiment, the nut 40 has an inner nut 41 and an outer nut 42.

The inner nut 41 has an overall cylindrical shape, and screws 41a and 41b are cut on the inner circumference and the outer circumference of the inner nut 41. The screw 41a on the inner circumference is screwed with the screw 11a cut on the shaft 11. That is, the screw 41a on the inner circumference is a female screw with respect to the screw 11a of the shaft 11. The outer peripheral screw 41b is screwed with the screw 42a cut on the inner circumference of the outer nut 42. That is, the outer peripheral screw 41b is a male screw for the screw 42a (see, for example, FIG. 2) of the outer nut 42. The outer peripheral screw 41b can be, for example, an M27 fine screw. The screw 41a cut on the inner circumference of the inner nut 41 and the screw 41b cut on the outer circumference are provided in the same direction; in this embodiment, the screws 41a and 41b are right-handed screws.

A hexagonal hole 41c is provided at the end of the inner nut 41 opposite to the washer 30 (see, for example, FIG. 2). This hole 41c is used by inserting a tool having a hexagonal columnar tip such as a hexagon wrench when fastening the members to be fastened 101 and 102 with the blind fastener 1. The hole 41c may have a polygonal shape.

The outer nut 42 is a hexagon nut in this embodiment, but its outer shape may be a polygonal shape. A screw 42a is cut on the inner circumference of the outer nut 42, and the screw 42a is screwed with the screw 41b on the outer circumference of the inner nut 41.

Operation

Operation of the blind fastener 1 will be described with reference to FIGS. 4 to 6. FIG. 5 is a side view when a plurality of members to be fastened are fastened with the blind fastener 1 according to the embodiment of the present invention. FIG. 6 is a cross-sectional view of FIG. 5. Unless otherwise specified, the fastening method will be described assuming that the fastening holes 103 of the members to be fastened 101 and 102 are aligned in the Z-axis direction.

First, as shown in FIG. 4, the blind fastener 1 is inserted into the fastening hole 103 from the side of the member to be fastened 101 in the state shown in FIG. 1. As a result, the first sleeve 20 whose tip has entered the fastening hole 103 and the head 12 of the bolt 10 are located on the side of the member to be fastened 102, and the counter washer 31 and the nut 40 are located on the side of the member to be fastened 101. In this state, a part of the first sleeve 20 and the second sleeve 32 including the tapered surfaces 21 and 32a is located in the fastening hole 103 of the member to be fastened 102, and the other part of the second sleeve 32 and the tapered portion 31c are located in the fastening hole 103 of the member to be fastened 101. In the present embodiment, the second sleeve 32 is located across the fastening holes 103 of the member to be fastened 101 and the member to be fastened 102.

The member to be fastened 101 is formed so that the fastening hole 103 becomes a countersunk hole. That is, the fastening hole 103 of the member to be fastened 101 has the same diameter as the fastening hole 103 of the member to be fastened 102 at the end on the side of the member to be fastened 102 (Z-axis negative direction), and it is formed by a tapered surface 103a (see FIG. 6) whose diameter is increased toward the side opposite to the side of the member to be fastened 102 (the Z-axis positive direction). The tapered surface 103a and the tapered surface 310 of the tapered portion 31c come into surface contact with each other.

Next, a commercially available tool such as a hexagon wrench is inserted into the hole 41c of the inner nut 41 to fix the inner nut 41; by applying torque to the outer nut 42 to rotate it, as shown in FIG. 5, the bolt 10 integrated with the inner nut 41 is pulled up in a relative manner in the positive direction of the Z axis. In the present embodiment, the coefficient of friction between the washer 30 (more specifically, the contact surface 31b of the counter washer 31) and the outer nut 42 is smaller than the coefficient of friction between the shaft 11 and the inner nut 41; further, each member is surface-treated by coating each member with, for example, a resin-based lubricant so that the friction coefficient between the bolt 10 and the first sleeve 20 is smaller than the friction coefficient between the shaft 11 and the inner nut 41. Therefore, even if the outer nut 42 rotates, the outer nut 42 and the inner nut 41 rotate in a relative manner; however, since there is no rotation between the inner nut 41 and the bolt 10, no torsional stress is generated in the bolt 10.

When the bolt 10 is pulled up, the tapered surface 21 of the first sleeve 20 and the tapered surface 32a of the second sleeve 32 come into contact with each other in the fastening hole 103, and the tapered surface 21 expands to the outside, that is, in a direction orthogonal to the axial direction, and comes into close contact with the inner surface of the hole forming the fastening hole 103. Further, since the first sleeve 20 presses the second sleeve 32 inward by the reaction force received from the inner surface of the hole, the second sleeve 32 is deformed so as to be in close contact with the shaft 11. As a result, the shaft 11, the second sleeve 32, and the first sleeve 20 are in close contact with each other in the fastening hole 103 without any gap. It is possible to prevent lateral displacement of the member to be fastened 102 in the XY plane orthogonal to the Z axis.

Further, in the member to be fastened 101, the tapered portion 31c, which is a first-side end of the washer 30, is fitted into the fastening hole 103, which is a countersunk hole, and since the tapered surface 103a of the fastening hole 103 and the tapered surface 310 of the tapered portion 31c are pressed by the axial force of the bolt 10 in a surface contact state, lateral displacement in the XY plane can be prevented. In this way, both the members to be fastened 101 and 102 are pressure-bonded by the blind fastener 1.

Further, when the outer nut 42 is rotated and the bolt 10 is relatively pulled up, the portion between a first-side end and the other-side end of the first sleeve 20 buckles outward as shown in FIGS. 5 and 6 to form the bulging portion 22. By further pulling up the bolt 10, the bulging portion 22 sits on the member to be fastened 102 and comes into close contact with the member to be fastened 102; the members to be fastened 101 and 102 are sandwiched between the bulging portion 22 and the washer 30 (more specifically, the counter washer 31) by the axial force of the bolt 10, and the members to be fastened 101 and 102 are frictionally joined.

As described above, according to the blind fastener 1, the fastening force can be improved because bearing-pressure bonding can be performed in addition to the friction bonding. The blind fastener 1 can be used for civil engineering or construction applications, especially for bridges.

Effects

The blind fastener 1 of the present embodiment is a blind fastener for fastening a plurality of members to be fastened 101, 102 having a fastening hole 103, equipped with a shaft 11 extending in one direction and inserted into the fastening hole 103; a bolt 10 having a head 12 of a diameter larger than that of the shaft 11 at a first-side end of the shaft 11; a first sleeve 20 having a cylindrical shape through which the shaft 11 is inserted, a first-side end of which is in contact with the head 12 and the other-side end of which is inserted into the fastening hole 103; a washer part 30 having a tubular shape through which the shaft 11 is inserted, arranged adjacent to the first sleeve 20 on the other-end side of the first sleeve 20 so as to be in contact with the member to be fastened 101, one-side end of which enters the fastening hole 103; and a nut 40 arranged adjacent to the washer 30 and screwed with the bolt 10; wherein tapered surfaces 310 and 32a, whose diameters are reduced toward the other-side end of the first sleeve 20, are formed on the portion of the washer 30 in contact with the member to be fastened 101 and on the first-side end thereof, respectively; a tapered surface 21 is formed on the other-side end of the first sleeve 20 so that the diameter increases toward the first-side end of the washer 30; and the other-side end of the first sleeve 20 and first-side end of the washer 30 are brought into contact with each other on the tapered surfaces 21 and 32a.

As a result, a plurality of members to be fastened 101 and 102 can be friction-fastened in addition to friction-bonded; therefore, the fastening force of the plurality of members to be fastened 101 and 102 can be improved without increasing the diameter of the shaft 11 of the bolt 10.

That is, since the axial force of the bolt 10 and the nut 40 applies a force in the extension direction (axial direction) of the shaft 11, a plurality of members to be fastened 101 and 102 to be welded can be friction-fastened. Further, since the tapered surface 310 formed in the portion in contact with the member to be fastened 101 is formed so that the diameter is reduced toward the other-side end of the first sleeve 20, and the member to be fastened 101 can be pressed in the axial direction by the axial force on the tapered surface 310, it is possible to prevent the member to be fastened 101 from moving (laterally shifting) in a direction orthogonal to the axial direction. Further, the tapered surface 32a at the first-side end of the washer 30 is reduced in diameter toward the other-side end of the first sleeve 20, and the tapered surface 21 at the other-side end of the first sleeve 20 is formed so as to be enlarged toward the first-side end of the washer 30; therefore, when both tapered surfaces 21 and 32a come into surface contact with each other due to an axial force, the other-side end of the first sleeve 20 can be brought into close contact with the inner surface of the hole forming the fastening hole 103 by receiving the reaction force, and the reaction force received from the inner surface of the hole by the other-side end of the first sleeve 20 can deform the first-side end of the washer 30 so as to be in close contact with the shaft 11.

Therefore, the fastening hole 103 is filled without a gap by the shaft 11, the first-side end of the washer 30, and the other-side end of the first sleeve 20, and it is possible to prevent the shaft 11 of the bolt 10 or the member to be fastened 102 from being displaced in a direction orthogonal to the axial direction. In this way, in addition to friction-fastening by axial force, the members to be fastened 101 and 102 can be pressure-fastened so as to prevent movement in a direction orthogonal to the axial direction, and the fastening force of the plurality of members to be fastened 101 and 102 can be improved.

Since the first-side end of the washer 30 and the other-side end of the first sleeve 20 are configured to enter the fastening hole 103, the diameter of the shaft 11 of the bolt 10 is smaller than the diameter of the fastening hole 103. Therefore, it is not necessary to align the fastening holes 103 of the members to be fastened 101 and 102 with high accuracy, and the same workability as the high-strength bolt can be obtained.

The washer part 30 has a counter washer 31, having a cylindrical body 31a through which the shaft 11 is inserted, a contact surface 31b provided at the end of the body 31a and in contact with the nut 40, a tapered portion 31c whose diameter is reduced toward the first-side end from the other-side end on the side opposite to the end of the body 31a, and a recess portion 31d provided at the tip where the tapered portion 31c is provided; and a second sleeve 32 which has a cylindrical shape and is fitted into the recess portion 31d and has a tapered surface at one end.

As a result, it is possible to improve the bearing pressure and expand the target of application to the members to be fastened 101 and 102. That is, since the counter washer 31 and the second sleeve 32 are made of separate members, they can be made of different materials. For example, the second sleeve 32 is made of a material that is more easily plastically deformed than the counter washer 31, or is made of a flexible material, so that the second sleeve 32 can be easily deformed toward the shaft 11 of the bolt 10, and the bearing pressure in the direction orthogonal to the axial direction of the bolt 10 to the shaft 11 can be improved. Further, since the counter washer 31 and the second sleeve 32 are made of separate members, the second sleeve 32 is fitted into the recess portion 31d of the counter washer 31; therefore, even if there is a change in the axial thickness of a plurality of members to be fastened due to changes in the thickness and number of members to be fastened and the like, it can be dealt with by replacing with a second sleeve 32 having a different length in the axial direction, and the target of application relative to the members to be fastened can be expanded.

The first sleeve 20 and the second sleeve 32 are made of a material that is more easily plastically deformed than the counter washer 31; the first sleeve 20 is made of a material that is more easily plastically deformed than the second sleeve 32. Due to the axial force of the bolt 10, the portion between one end and the other end buckles outward to form a bulging portion 22 that sandwiches the plurality of fastened members 101 and 102 with the counter washer 31.

As a result, the first sleeve 20 is made of a material that is more easily plastically deformed than the second sleeve 32, so that due to the axial force, the portion between the first-side end and the other-side end buckles outward to form a bulging portion 22 that sandwiches the plurality of members to be fastened 101 and 102 with the washer 30, making it possible to facilitate frictional fastening of a plurality of members to be fastened 101 and 102. Further, when the bolt 10 is pulled in a relative manner toward the nut 40 by the axial force, the tapered surfaces 21 and 32a of the first sleeve 20 and the second sleeve 32 come into contact with each other, and the second sleeve 32 comes into contact with the recess portion 31d of the counter washer 31. Here, since the counter washer 31 is harder than the second sleeve 32 and the first sleeve 20 is made of a material that is more easily plastically deformed than the second sleeve 32, and since the reaction force of the axial force is applied to the other end of the first sleeve 20 via the second sleeve 32, the other end of the first sleeve 20 can be easily opened to the outside. Therefore, the friction between the first sleeve 20 and the shaft 11 can be eliminated or reduced, so that the bolt 10 can be further pulled toward the nut 40, resulting in facilitating fastening of the bearing.

The nut has an inner nut 41 that is screwed with a screw cut on the shaft 11 on the inner circumference, and an outer nut 42 provided on the outer circumference of the inner nut 41 and screwed with a screw cut on the outer circumference of the inner nut 41; the inner nut 41 is formed so that the screw 41a cut on the inner circumference to be screwed with the shaft 11 and the screw 41b cut on the outer circumference to be screwed with the outer nut 42 are formed in the same direction.

As a result, the outer nut 42 and the bolt 10 are physically in a non-contact state, so that it is possible to prevent the bolt 10 from being twisted by the rotation of the outer nut 42. In particular, with the inner nut 41, because the inner peripheral screw 41a screwed with the bolt 10 and the outer peripheral screw 41b screwed with the outer nut 42 run in the same direction, even if the inner nut 41 rotates in the right-handed direction (the direction in which the inner nut 41 advances in the Z-axis positive direction relative to the outer nut 42) as the outer nut 42 rotates, since the bolt 10 is in the same status as that of rotating in the loosening direction, it is possible to prevent torsional stress from being applied to the bolt 10; consequently, it is possible to prevent a part of the torque from being consumed by the torsional stress, and to use all but the friction torque between the outer nut 42 and the washer 30 of the applied torque for the axial tensile stress (that is, the axial force).

Therefore, the axial force can be increased to improve the fastening force with the same bolt 10.

The coefficient of friction between the washer 30 and the outer nut 42 is made to be less than the coefficient of friction between the shaft 11 and the inner nut 41, and the coefficient of friction between the bolt 10 and the first sleeve 20 is made to be less than the coefficient of friction between the shaft 11 and the inner nut 41.

As a result, the bolt 10 and the inner nut 41 are relatively fixed, and both are integrated, so that the rotation of the outer nut 42 pulls up the inner nut 41 and the bolt 10 to form a bulging portion 22 on the first sleeve 20, and a plurality of members to be fastened 101 and 102 can be fastened by friction-fastening between the bulging portion 22 and the washer 30 (counter washer 31). Therefore, for example, a commercially available tool at least having a hexagonal columnar tip, such as a hexagon wrench, may be inserted into the hole 41c to rotate the outer nut 42. No special tool is required, and the fastening work can be performed with a commercially available tool.

The shaft 11 is formed with fine screws.

As a result, the effective cross-sectional area is increased and the axial force can be increased relative to the bolt 10 on which the coarse threads are formed, so that the fastening force of the members to be fastened 101 and 102 can be improved. In particular, by using a bolt in which fine screws of M18 or less (that is, a pitch of 2.0 mm or less) are formed, a slip coefficient equivalent to M22F10T of friction-fastening can be obtained with a stress equivalent to F10T without the risk of delayed fracture.

### OTHER EMBODIMENTS

The present invention is not limited to the above embodiments, but also includes other embodiments shown below. The present invention also includes a combination of any or all of the above embodiments and the following other embodiments. Furthermore, various omissions, replacements and changes can be made to these embodiments without departing from the scope of the invention, and modifications thereof are also included in the present invention.
1 Blind fastener
10 Bolt
11 Shaft
11a Screw
12 Head
20 1st sleeve
21 Tapered surface
22 Bulge portion
30 Washer
31 Counter washer
31a Body
31b Contact surface
31c Taper portion
310 Tapered surface
31d Recess portion
32 Second sleeve
32a Tapered surface
40 Nut
41 Inner nut
41a Inner circumference screw
41b Outer circumference screw
41c Hole
42 Outer nut
41a Screw
101 Member to be fastened
102 Member to be fastened
103 Fastening hole
103a Tapered surface

What is claimed is:

1. A blind fastener for fastening a plurality of members to be fastened having fastening holes, equipped with a bolt having a shaft that extends in one direction and is inserted into the fastening hole, and a head with a diameter larger than that of the shaft at one end of the shaft; a first sleeve having a cylindrical shape through which the shaft is inserted, a first-side end of which is in contact with the head and the other-side end of which is inserted into the fastening hole;
a washer portion that has a tubular shape through which the shaft is inserted, is arranged adjacent to the first sleeve on the other-end side of the first sleeve so as to be in contact with the member to be fastened, a first-side end of which entering the fastening hole; and
a nut arranged so as to be adjacent to the washer portion and screwed with the bolt;
wherein a tapered surface having a diameter reduced toward the other-side end of the first sleeve is formed on a portion of the washer portion in contact with the member to be fastened and first-side end thereof,
a tapered surface whose diameter increases toward the first-side end of the washer is formed at the other-side end of the first sleeve, and
the other-side end of the first sleeve and the first-side end of the washer portion are in contact with each other on the tapered surfaces.

2. The blind fastener according to claim 1, wherein the washer has a counter washer, having
a cylindrical body through which the shaft is inserted, a contact surface provided at the end of the body and in contact with the nut, a tapered portion whose diameter is reduced from the other-side end of the body on the opposite side toward the first-side end, and a recess portion provided at the tip where the tapered portion is provided;
and a second sleeve having a cylindrical shape, that is fitted into the recess portion and has a tapered surface at the first-side end.

3. The blind fastener according to claim 2, wherein the first sleeve and the second sleeve are made of a material that is more easily plastically deformed than the counter washer,
the first sleeve is made of a material that is more easily plastically deformed than the second sleeve, and
by the axial force of the bolt, the portion between the first-side end and the other-side end buckles outward to form a bulging portion that sandwiches the plurality of members to be fastened with the counter washer.

4. The blind fastener according to claim 1, wherein the nut has an inner nut screwed into the screw cut on the shaft on the inner circumference, and an outer nut provided on the outer circumference of the inner nut and screwed with a screw cut on the outer circumference of the inner nut; wherein the inner nut is formed with the screw cut on the inner circumference screwed with the shaft and the screw cut on the outer circumference screwed with the outer nut running in the same direction.

5. The blind fastener according to claim 4, wherein the coefficient of friction between the washer and the outer nut is smaller than the coefficient of friction between the shaft and the inner nut, and the coefficient of friction between the bolt and the first sleeve is smaller than the coefficient of friction between the shaft and the inner nut.

6. The blind fastener according to claim 1, wherein the shaft has a fine screw formed thereon.

7. The blind fastener according to claim 1, wherein the nut has an inner nut screwed into the screw cut on the shaft on the inner circumference, and an outer nut provided on the outer circumference of the inner nut and screwed with a screw cut on the outer circumference of the inner nut; wherein the inner nut is formed with the screw cut on the inner circumference screwed with the shaft and the screw cut on the outer circumference screwed with the outer nut running in the same direction.

8. The blind fastener according to claim 1, wherein the nut has an inner nut screwed into the screw cut on the shaft on the inner circumference, and an outer nut provided on the outer circumference of the inner nut and screwed with a screw cut on the outer circumference of the inner nut; wherein the inner nut is formed with the screw cut on the inner circumference screwed with the shaft and the screw cut on the outer circumference screwed with the outer nut running in the same direction.

9. The blind fastener according to claim 7, wherein the coefficient of friction between the washer and the outer nut is smaller than the coefficient of friction between the shaft and the inner nut, and the coefficient of friction between the bolt and the first sleeve is smaller than the coefficient of friction between the shaft and the inner nut.

10. The blind fastener according to claim 8, wherein the coefficient of friction between the washer and the outer nut is smaller than the coefficient of friction between the shaft and the inner nut, and the coefficient of friction between the bolt and the first sleeve is smaller than the coefficient of friction between the shaft and the inner nut.

11. The blind fastener according to claim 2, wherein the shaft has a fine screw formed thereon.

12. The blind fastener according to claim 3, wherein the shaft has a fine screw formed thereon.

13. The blind fastener according to claim 4, wherein the shaft has a fine screw formed thereon.

14. The blind fastener according to claim 7, wherein the shaft has a fine screw formed thereon.

15. The blind fastener according to claim 8, wherein the shaft has a fine screw formed thereon.

16. The blind fastener according to claim 5, wherein the shaft has a fine screw formed thereon.

17. The blind fastener according to claim 9, wherein the shaft has a fine screw formed thereon.

18. The blind fastener according to claim 10, wherein the shaft has a fine screw formed thereon.
